(19) United States
(12) Patent Application Publication
(10) Pub. No.: US 2021/0244010 A1
(43) Pub. Date: Aug. 12, 2021

(54) ULTRASOUND CONTROLLED SPOT SPRAYER FOR ROW CROPS

(71) Applicant: Martin Perry Heard, Lubbock, TX (US)

(72) Inventor: Martin Perry Heard, Lubbock, TX (US)

(21) Appl. No.: 16/909,439

(22) Filed: Jun. 23, 2020

Related U.S. Application Data
(60) Provisional application No. 62/975,586, filed on Feb. 12, 2020.

(51) Int. Cl. A01M 7/00

(52) U.S. Cl. CPC A01M 7/0089; A01M 21/043

(57) ABSTRACT

The present invention relates to a novel apparatus for delivering herbicide and/or fertilizer to row crops.

### BACKGROUND OF THE INVENTION

The present invention relates to a novel apparatus for delivering herbicide to row crops. Current technology for delivering herbicide often lacks precision to distinguish between the crop being protected and the weed. This has led to the need for using selective herbicide, along with crop plants that are genetically engineered to resist the herbicide.

Attempts to apply herbicide in a controlled manner to weeds without exposing the crop plants have encountered difficulties. This is particularly the case where herbicide is intended for application to weed plants that are taller than the crop plants. There is a need for systems that are simple yet capable of detecting weeds relative to crop plants and delivering herbicide in a controlled manner.

### SUMMARY OF THE INVENTION

The present invention relates to a herbicide spraying apparatus that uses ultrasound detectors that flank both sides of the herbicide spray nozzle in a repeating array, and connected to a controller that is capable of activating the herbicide spray nozzle in response to detection of weeds within a row crop.

### BRIEF DESCRIPTION OF THE DRAWINGS

FIG. 1 shows a sprayer in accordance with an embodiment of the invention applying herbicide to weeds.

FIG. 2 shows detail of the spray nozzle and detector layout according to an embodiment of the invention.

FIG. 3 shows a circuit diagram showing connections of the components of the sprayer according to an embodiment of the present invention.

### DETAILED DESCRIPTION OF THE INVENTION

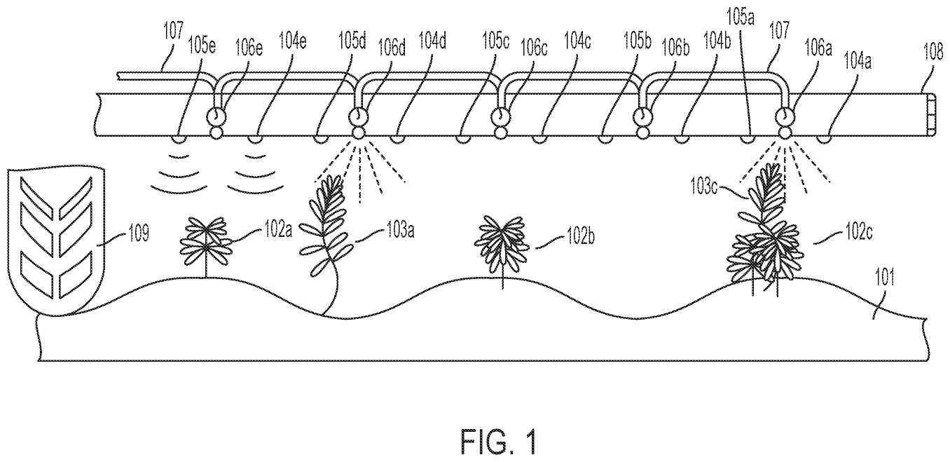

The current disclosure relates to row crop spray apparatus such as shown in FIG. 1. The apparatus is designed to support row crops grown in soil 101 and consisting of plants 102a, 102b, 102c which according to a preferred embodiment include cotton. However, other suitable crops such as corn, lettuce, and tomatoes are contemplated. The apparatus of the present invention is particularly adapted to detect weeds 103a, 103c based on the difference in height between the crop plant 102a, 102b and the weed plant 103a, 103c. Notably, the present invention is capable of distinguishing between weed plants 103c and crop plants 102c based on height difference even where the plants are growing in the same place as shown in FIG. 1.

The apparatus includes an array of first-side ultrasound detectors 104a, 104b, 104c, 104d, 104e, and an array of second-side ultrasound detectors 105a, 105b, 105c, 105d, 105e. Each of the first-side and second-side detectors is positioned on either side of a spray nozzle 106a, 106b, 106c, 106d, 106e. The spray nozzles 106a, 106b, 106c, 106d, 106e are each connected to an herbicide conduit 107 that supplies herbicide to each of the spray nozzles, and are mounted on a boom 108. The boom 108 in a preferred embodiment includes wheels 109 for translating the apparatus over the row crop. In one alternative embodiment, the boom is positioned on a tractor that has been adapted for delivery of herbicide.

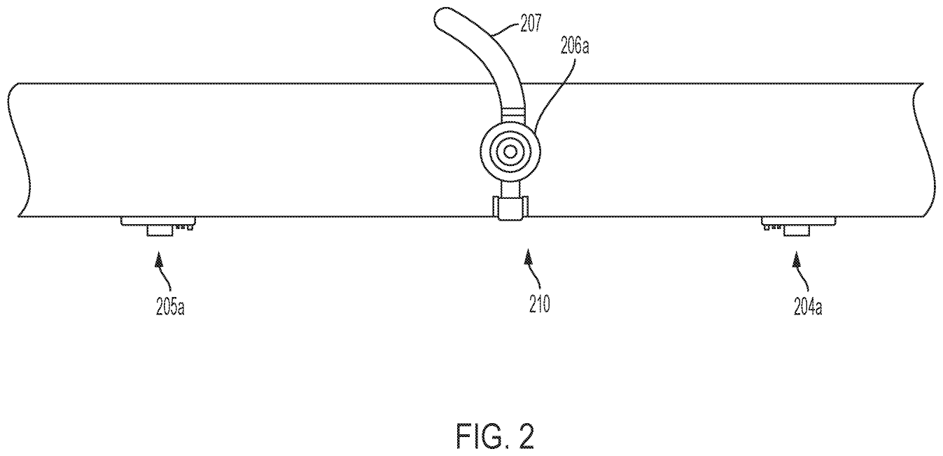

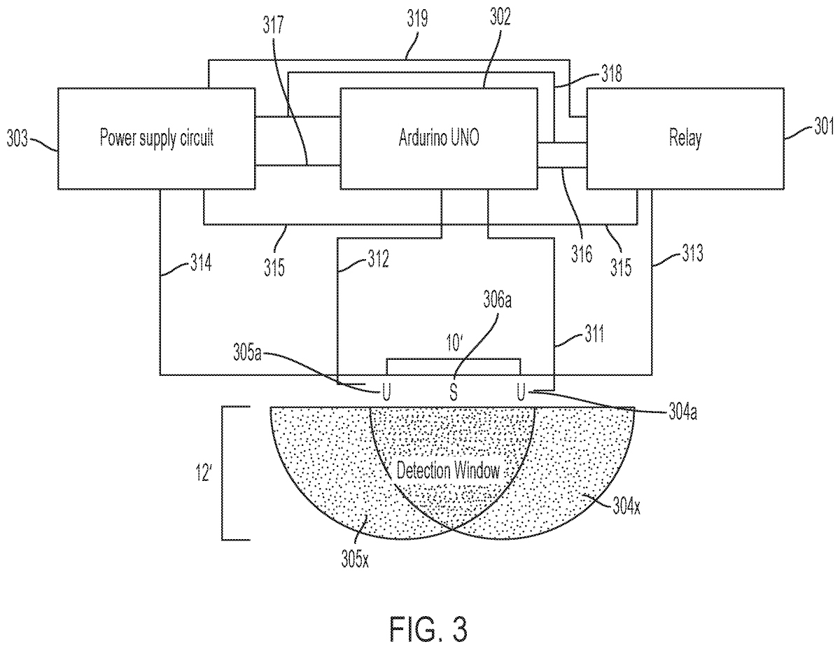

A closer view of the apparatus is shown in FIG. 2. A first-side ultrasound detector 204a is positioned on one side of an herbicide nozzle 206a, and a second-side ultrasound detector 205a is positioned on the other side of the nozzle 206a. The nozzle 206a includes a spray head 210, and is connected at the other end to an herbicide supply conduit 207. The nozzle 206a and ultrasound detectors 204a and 205a are connected to a controller as shown in FIG. 3 below. The distance between each ultrasound detector range from 5 to 15 inches, with 10 inches being preferred. When the distance between detectors is 10 inches the detectors 204a, 204b are preferably spaced evenly 5 inches away from the nozzle 206a. The distance between the detectors may be increased if the height of the detection window is increased. However, the 10 inch distance between detectors is ideal when the detection window is approximately 12 inches.

The control system for the apparatus of the invention includes a relay 301, a controller 302, and a power supply 303 as shown in FIG. 3. The first side detector 304a is electrically connected to the controller 302 through signal wire 311, and the second side detector 305a is connected to the controller 302 through the signal wire 312. It should be appreciated that for an array of detectors, each detector is connected to the controller 302 by way of its own signal wire.

The spray nozzle 306a is connected to the relay 301 via a wire 313, which is typically a 12-volt connection. The spay nozzle is also connected to the power supply through ground wire 314. The relay 301 is also connected to the power supply 303 through a wire 315, which is the same voltage as wire 313, and when the relay is activated supplies power through the relay 301 to the spray nozzle 306a.

The relay 301 receives signal from the controller 302 through signal wire 316. The relay 301 and controller 302 receive power from the power supply 303 through power wire 318. The voltage supplied in the wire 318 may typically be a lower voltage needed to control the electronics of the relay 301 and controller 302, and is typically a 5 volt wire. The relay 301 is grounded to the power supply through ground line 319. The controller 302 is grounded to the power supply 303 through ground wire 317. A person of skill will recognize that grounding may be accomplished through a ground connection to the metallic boom or another part of the apparatus as an alternative to using a grounding wire.

The apparatus constructed in this manner includes overlapping detection windows 304x and 305x. This configuration has been shown particularly effective for distinguishing weeds 103a, 103c from row crop plants 102a, 102b, 102c.

Other embodiments and uses of the invention will be apparent to those skilled in the art from consideration of the specification and practice of the invention disclosed herein. All references cited herein, including all U.S. and foreign patents and patent applications, are specifically and entirely hereby incorporated herein by reference. It is intended that the specification and examples be considered exemplary only, with the true scope and spirit of the invention indicated by the following claims

What is claimed is:

1. An apparatus for application of herbicide to row crops comprising:
a first ultrasound detector in electrical communication with a controller;
a second ultrasound detector in electrical communication with the controller;
a spray nozzle connected to a relay, the relay being connected to the controller, wherein the spray nozzle is activated through a signal from the controller that is based on detection of a weed by the first ultrasound detector and second ultrasound detector.

2. The apparatus of claim 1, further comprising a first power supply line connecting a power supply to the relay, and a second power supply line connecting the relay to the spray nozzle.

3. The apparatus of claim 1, further comprising a second power supply line connecting a power supply with the controller and the relay.

4. The apparatus of claim 1, further comprising a first signal wire connecting the first ultrasound detector to the controller, and a second signal wire connecting the second ultrasound detector to the controller.

5. A method for application of herbicide to row crops comprising:
moving an apparatus over a plurality of rows of crop, the apparatus comprising:
a first ultrasound detector in electrical communication with a controller;
a second ultrasound detector in electrical communication with the controller;
a spray nozzle connected to a relay, the relay being connected to the controller;
activating the spray nozzle through a signal from the controller when a weed is detected by the first ultrasound detector and second ultrasound detector.

6. The method of claim 5, further comprising a first power supply line connecting a power supply to the relay, and a second power supply line connecting the relay to the spray nozzle.

7. The method of claim 5, further comprising a second power supply line connecting a power supply with the controller and the relay.

8. The method of claim 5, further comprising a first signal wire connecting the first ultrasound detector to the controller, and a second signal wire connecting the second ultrasound detector to the controller.
